(19) United States
(12) Patent Application Publication
(10) Pub. No.: US 2002/0068198 A1
(43) Pub. Date: Jun. 6, 2002

(54) Data storage media

(76) Inventors: Donald J. Kerfeld, St. Paul, MN (US); Terry L. Morkved, St. Paul, MN (US); Robert F. Hellen, Vadnais Heights, MN (US)

Correspondence Address: Attention: Eric D. Levinson, Imation Corp., Legal Affairs, P.O. Box 64898, St. Paul, MN, 55164-0898, US

(21) Appl. No.: 09/730,199

(22) Filed: Dec. 5, 2000

(51) Int. Cl. G11B 5/64

(52) U.S. Cl. 428/694 TR

(57) ABSTRACT

In one embodiment, a data storage medium includes at least three layers. The first layer may be a substrate. The second layer includes a polymer and may exhibit surface variations. And the third layer may substantially conform to the surface variations of the second layer. The surface variations may be used to encode read-only data, servo patterns, or other tracking patterns on a data storage medium at very low cost. The surface variations may be detectable on the surface of the medium because the third layer substantially conforms to the variations. Additional layers may be added to the medium so long as they substantially conform to the surface variations such that the variations are exhibited on the surface of the medium.

### BACKGROUND

The present invention relates to data storage media.

Many types of data storage media have been developed to store information. They include hard drives, magnetic diskettes, magnetic tapes, magnetic tape cartridges, optical disks, magneto-optical disks and phase-change disks to name a few. Increasing data storage density is a paramount goal in the development of new or improved types of data storage media. Reducing production costs is another. As data storage needs continue to expand into aspects of everyday life, it becomes more desirable to develop high-density data storage media that can be fabricated at relatively low cost.

One particular type of data storage media is referred to as flying head media. A flying head medium typically includes a disk that can be written to, or read by a “flying head” as described below. In operation, the disk is spun, and as the disk spins, friction between the disk and the atmosphere causes air to flow along with the disk. This flowing air, in turn, passes under the head, suspending the head just above the disk surface. The fly height, defined as the mean distance between the disk and the head, is typically less than 50 nanometers, and may be less than 25 nanometers. This tiny distance between the head and the disk enables higher density storage capabilities than can be achieved with larger separations. A lubrication layer is often maintained on the disk surface to help protect the disk from data corruption if the head comes in contact with the disk.

One common example of a flying head medium is contained in a hard drive. Hard drives typically have a data storage disk and a read/write head encapsulated within a housing. The data storage disk typically includes a substrate layer, a magnetic thin film stack layer including a hard coat, and a lubrication layer. In operation, a hard drive unit spins the data storage disk and the read/write head is suspended above the disk. The read/write head can magnetically write data to the data storage disk by arranging and orienting magnetic domains in the thin film stack. The read/write head can magnetically read this data by detecting the magnetization of the domains. Writing servo patterns on hard disks is generally a major expense in the fabrication process because each data storage disk must be individually written with those patterns.

Another type of data storage media is contact head media. Contact head media include flexible media, such as floppy disks, or magnetic storage tape. Unlike flying head media, however, contact head media intentionally come in physical contact with a read or read/write head during operation.

### SUMMARY

The invention, in an exemplary embodiment, provides a data storage medium having at least three layers. The first layer may be a substrate. The second layer may exhibit surface variations. And the third layer may substantially conform to the surface variations of the second layer. The second layer may reside on top of the first layer and the third layer may reside on top of the second layer. Thus the surface variations may be exhibited on the exterior medium surface.

The first layer may provide mechanical properties to the medium. These properties may include, but are not limited to rigidity, mechanical stability, stiffness, shock resistance, flatness, run-out, waviness, surface roughness, or vibrational properties. Glass, aluminum, aluminum-magnesium, ceramic, plastic or other generally rigid substrate materials work well for these purposes. In some embodiments, the first layer may have a generally planer surface and in other embodiments, the first layer may be substantially transparent so as to allow light to pass through the substrate during media fabrication. By way of example, the first layer may be approximately 0.3 mm to 1.0 mm thick. Depending on the composition of the first layer, a primer may be added to the first layer to facilitate or enhance bonding between the first and second layers.

The second layer may include a polymer. Moreover, the polymer may include a photopolymerized material known as a photopolymer. The surface variations exhibited on the second layer may be arranged in a machine-readable pattern and may be detectable by one or more types of transducers, such as a magnetic read (MR) head, a pressure sensitive transducer, or a temperature sensitive transducer. In one particular system, the surface variations are detected by a flying MR element that is sensitive to temperature variation in addition to magnetic characteristics. By way of example, the second layer may be less than 50 microns thick, although the scope of the invention is not limited in this respect. In one particular embodiment, the second layer may be less than 10 microns thick.

The surface variations may be embossed, etched, molded, ablated, or the like, on the polymer material and may be arranged as data patterns defined by bumps. Alternatively, the surface variations could be patterns of rails, lands, pits, grooves, channels, ridges, or any combination of bumps, rails, lands, pits, grooves, channels or ridges. In addition, the surface variations may provide roughness or texture to the medium. Importantly, however, the surface variations in the second layer are preserved on at least one outer surface of the medium because the third layer substantially conforms to the surface variations. Thus, a surface pattern on the second layer may be generally imposed on the third layer.

The surface variations may contain servo patterns or tracking patterns, and in some embodiments the surface variations may represent encoded data. Regardless of content, however, the surface variations may be pre-written at relatively low cost in a read-only format, e.g. by processes such as stamping, embossing, molding, ablation, or the like.

The surface variations may have at least one lateral dimension less than one micron. If the surface variations are depressions, such as pits or grooves, the variations may be 20 nm to 150 nm deep. If the surface variations project from the medium, they may project a height less than the fly height, ensuring that the article maintains a flyable surface by avoiding head-to-medium collisions.

In one specific embodiment, the surface variations include a plurality of oval shaped data bumps, some having a surface area less than 40,000 square nanometers. Again, these data bumps may project from the medium to a height less than the fly height. For instance, a medium designed to fly at a height of 25 nm may have bumps that project form the article to a height less than 20 nm. Bumps of this size may allow significant areal density of read-only data (>5 Gigabits/in²) while still ensuring that the article maintains a flyable surface for a read head.

The third layer may include a recording layer and that recording layer may be comprised of a magnetic recording material. In one embodiment, the third layer includes a thin film stack for storing encoded data. Thus, the third layer may include a plurality of sub-layers that together form a recording structure. The thin film stack may be a magnetic thin film stack, or an optical thin film stack, such as a magneto-optical thin film stack or phase change thin film stack. The thin film stack may include a hard coat made from a material such as carbon, hydrogenated-carbon, or nitrogenated-carbon (e.g. carbon reacted with nitrogen). In addition, the thin film stack may include a buffer and/or seed layer to improve a sputtering fabrication process of the thin film stack. Furthermore, for an optical thin film stack, the stack may include one or more phase change layers, a reflector layer, a spacer layer, or a barrier layer.

The data storage medium may also include additional layers that substantially conform to the surface variations of the second layer. For instance, in one embodiment the medium includes a fourth layer having a lubricating material. The fourth layer may reside on top of the third layer and may help ensure against data corruption if a flying read head were to come into contact with the medium surface. Moreover, because the fourth layer substantially conforms to the surface variations, the surface variations may be exhibited on the medium surface.

The invention, in another exemplary embodiment provides a data storage medium having a substantially rigid substrate, and a polymer layer containing surface variations. The data storage medium may further include additional layers such as a thin film stack and a lubricating layer, where both the thin film stack and the lubricating layer substantially conform to the surface variations on the polymer layer. Substantially conforming the additional layers to the polymer layer ensures that the surface variations are exhibited on the surface of the medium. In this manner, the surface variations may be transducer detectable on the medium surface.

In yet another exemplary embodiment, a data storage medium includes a flexible contact media substrate and a polymer layer containing surface variations. The data storage medium may further include one or more additional layers such as a thin film stack. The thin film stack may substantially conform to the surface variations on the polymer layer, ensuring that the surface variations are transducer detectable on the surface of the medium. In addition, the medium may have a lubricating layer that also substantially conforms to the surface variations. The substrate may contain magnetically or optically encoded data.

In still another exemplary embodiment, a data storage medium includes a substantially transparent plastic substrate and a polymer layer containing surface variations. Because the substrate may be substantially transparent, the polymer layer may be exposed to radiation through the substrate during a media fabrication stamping process. Again, the medium may further include additional layers such as a thin film stack that substantially conforms to the surface variations on the polymer layer and a lubrication layer that substantially conforms to the surface variations. In addition, the data storage medium may further include a reflective layer and a phase change thin film stack for optically encoded data storage.

In some embodiments, the substantially transparent plastic substrate may be part of a conventional optical medium. The substrate itself may be stamped, embossed or otherwise provided with optically detectable features such as bumps, rails, lands, pits, grooves, channels or ridges. A reflective layer may allow optical energy to reflect off the medium and diffract in accordance with the optically detectable features. In this manner optically encoded data may be provided on the medium.

In still another exemplary embodiment, a data storage medium includes a first data storage layer and a second data storage layer, the second data storage layer including a polymer layer containing surface variations. And again, the media may also include additional layers such as a thin film stack that substantially conforms to the surface variations on the polymer layer, ensuring that the surface variations are transducer detectable on the surface of the medium. In addition, the medium may have a lubrication layer that also substantially conforms to the surface variations. The first data layer may contain read-only data or re-writeable data while the surface variations on the second layer contain read-only data.

In yet another exemplary embodiment, a removable hard disk unit includes a housing, and at least one data storage unit within the housing. The data storage unit may include a first layer, a second layer, and a third layer. The first layer may be a substrate. The second layer may exhibit surface variations and the third layer may substantially conform to those surface variations. Additional layers, as described herein, may also be added so long as they substantially conform to the surface variations of the second layer. The physical structure, composition and ordering of the different layers of data storage unit may be the same as that of data storage media as described herein. In other embodiments, a removable hard disk unit includes a housing and multiple data storage units within the housing.

In still yet another exemplary embodiment, a hard drive unit includes a housing, at least one flying head transducer within the housing, and at least one data storage unit within the housing. The data storage unit may include a first layer, a second layer, and a third layer. The first layer may be a substrate. The second layer may exhibit surface variations and the third layer may substantially conform to those surface variations. Additional layers, as described herein, may also be added so long as they substantially conform to the surface variations of the second layer. The physical structure, composition and ordering of the different layers of data storage unit may be the same as that of data storage media as described herein. In other embodiments, a hard drive unit includes a housing, one or more flying head transducers within the housing, and multiple data storage units within the housing.

In another exemplary embodiment the invention provides methods and techniques for media fabrication. The method may include providing a substrate and applying a layer of photopolymer material on the substrate. The method may also include embossing surface variations on the photopolymer material and exposing the photopolymer material to radiation through the substrate. A thin film stack may be deposited on the photopolymer such that it substantially conforms to the surface variations. In addition, a lubricant monolayer may be added on top of the thin film stack such that the lubricant monolayer also substantially conforms to the surface variations.

In another exemplary embodiment the invention provides a method comprising providing substrate and applying a polymer film on the substrate. The substrate may have a generally planer surface, and may be comprised of aluminum, glass, aluminum-magnesium, ceramic, plastic or any other substantially rigid material. In one embodiment, the substrate is comprised of a substantially transparent material. One or more surface variations may be created on the film. Then, one or more additional layers may be applied over the film such that each additional layer substantially conforms to the surface variations. Applying a film on the substrate may comprise spin coating the substrate or roll coating the substrate. Creating one or more surface variations may comprise stamping the film with a stamper and exposing the stamped film to radiation. In other embodiments, applying a film on the substrate and creating the one or more surface variations may comprise an injection molding process or a rolling bead process.

Additional details of one or more embodiments, including techniques for fabrication are set forth in the accompanying drawings and the description below. Other features objects and advantages will become apparent from the description and drawings, and from the claims.

### DESCRIPTION OF THE DRAWINGS

FIGS. 1-7 are cross-sectional diagrams of a data storage medium.

FIGS. 8 and 9 are top view diagrams of data storage media in the form of disks.

FIG. 10 is the same cross sectional diagram of FIG. 1 with a flyable transducer flying over the medium.

FIG. 11 is another cross sectional diagram of a data storage medium.

FIG. 12 is a flow diagram illustrating one fabrication technique for creating a data storage medium.

FIG. 13 is another cross sectional diagram of a data storage medium.

FIG. 14 is yet another cross sectional diagram of a data storage medium.

FIG. 15 is a diagram showing a data storage medium encased in a housing.

FIG. 16 is a diagram showing a hard disk unit.

### DETAILED DESCRIPTION

Surface variations may be purposefully added to a wide variety of different types of data storage media to increase data storage densities, decrease production costs, or both. Among other things, the surface variations may be used to encode read-only data, servo patterns, or other tracking patterns on a data storage medium at very low cost. For instance, surface variations may be added to a data storage medium layer during fabrication. Additional layers added on top of the layer with surface variations may have concomitant conforming surface variations to ensure that the variations are exhibited and detectable on the medium surface.

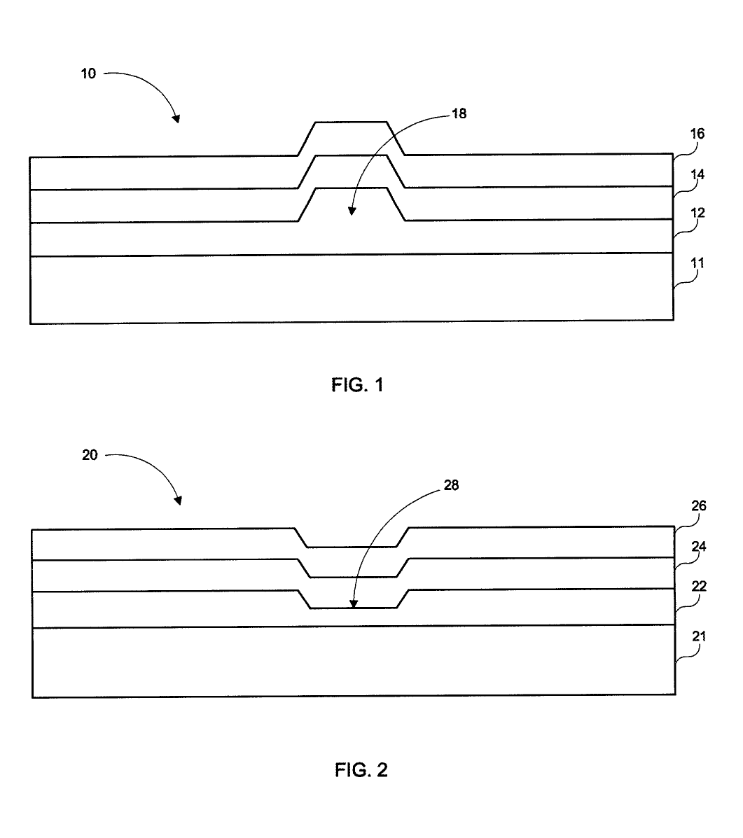

FIG. 1 is a cross-sectional diagram of an exemplary embodiment of a data storage medium 10. The medium 10 may include a first layer 11, a second layer 12, a third layer 14, and a fourth layer 16. The first layer 11 may take the form of a substrate and may provide rigidity and mechanical stability to the article. In some particular embodiments, first layer 11 is made out of glass, aluminum, aluminum-magnesium, ceramic or plastic. In other embodiments, the first layer is substantially transparent, such that at least some light is able to pass through it.

The second layer 12 may include a polymer layer. The polymer layer may take the form of a polymeric material such as a photopolymer. Moreover, this photopolymer material may be embossed, molded, ablated, or otherwise provided with one or more surface variations 18, e.g. using a stamping, molding, embossing, or ablating technique, or the like.

The third layer 14 may include a thin film stack that substantially conforms to the surface variations 18. In this manner, the integrity of surface variations 18 may be preserved on the surface of the medium. The variations in third layer may be concomitant conforming variations that substantially conform to the second layer 12.

In other embodiments, the third layer 14 may include a hard coat. The hard coat may add durability and protection to the medium and may include materials such as carbon, hydrogenated-carbon, or nitrogenated-carbon (e.g. carbon reacted with nitrogen). In addition, a buffer and/or underlayer may be included in the third layer 14. The buffer may provide environmental protection between the thin film stack and the substrate. The underlayer may help nucleate and grow microstructures during fabrication to give the thin film stack the appropriate magnetic properties. The thin film stack may include ferromagnetic materials having the desired magnetic characteristics. These ferromagnetic materials may be magnetically oriented and detected by magnetic read/write heads to facilitate data storage and manipulation. The hard coat may cover the thin film stack to protect its integrity. Importantly, however, regardless of its composition, the structure of third layer 14 substantially conforms to the surface variations 18. In this manner, the pattern of surface variations 18 can be imposed in third layer 14 as concomitant conforming surface variations.

The fourth layer 16 may include a lubricating material substantially conforming to surface variations 18. Thus, the pattern of surface variations 18 can be imposed in fourth layer 16 as concomitant conforming surface variations. The lubricating material may serve to reduce friction and wear on the medium surface, and may include a perfluoropolyether organic polymer. Again, substantially conforming the lubricating material to the surface variations 18 may ensure that the integrity of surface variations 18 are preserved through the fourth layer 16.

FIG. 2 is another cross-sectional diagram showing an exemplary embodiment of data storage medium 20. As shown, a surface variation 28 may be a depression rather than a protrusion as shown at 18 in FIG. 1. For instance, surface variation 28 may be a pit, channel, groove, or the like. Importantly, all the layers above the second layer 22 exhibit concomitant conforming surface variations such that they substantially conform to the surface variations 28 on the second layer 22.

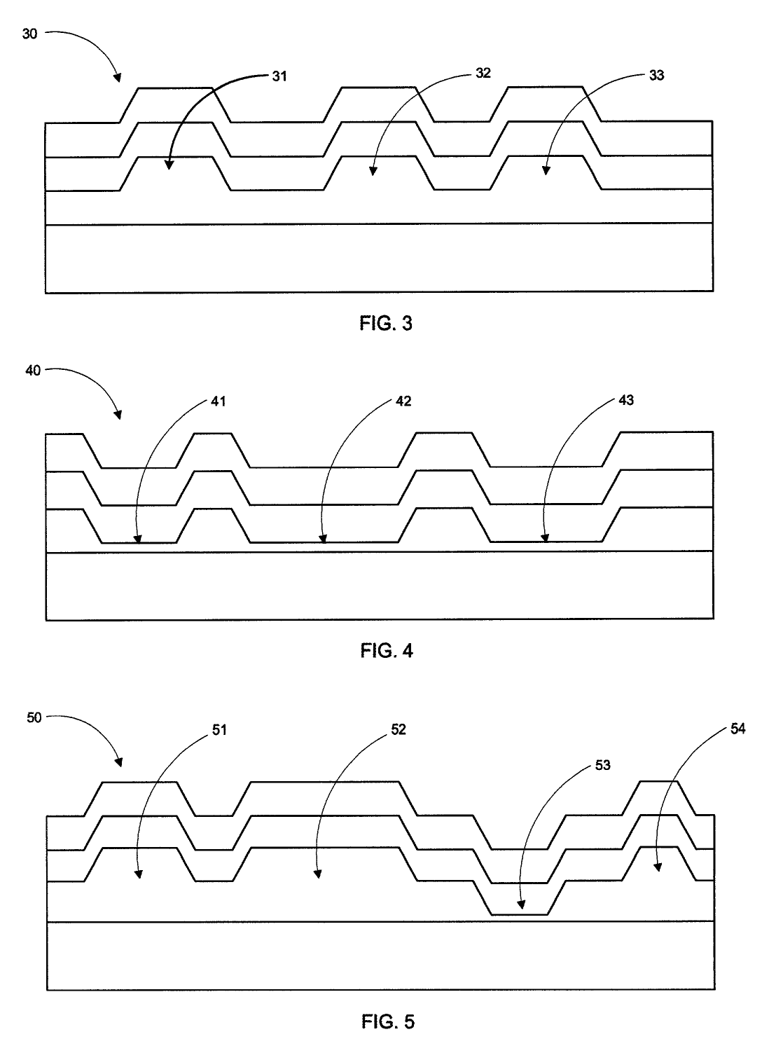

As shown in FIGS. 3-5, exemplary data storage media 30, 40, 50 typically has a plurality of surface variations. For instance, as shown in FIG. 3, a data storage medium 30 may have a plurality of protrusions 31, 32, 33. These protrusions may be bumps, rails, lands, ridges, or the like. Similarly, as shown in FIG. 4, a data storage medium 40 may have a plurality of depressions 41, 42, 43, which may be pits, channels, groves, or the like. As shown in FIG. 5, a data storage medium 50 may have both depressions 53 and protrusions 51, 52, 54. Moreover, in particular embodiments, a medium 50 has surface variations including a depression immediately following a protrusion 52, 53, or a protrusion immediately following a depression 53, 54. Once again, however, all the layers above the layer exhibiting the surface variations substantially conform to the surface variations.

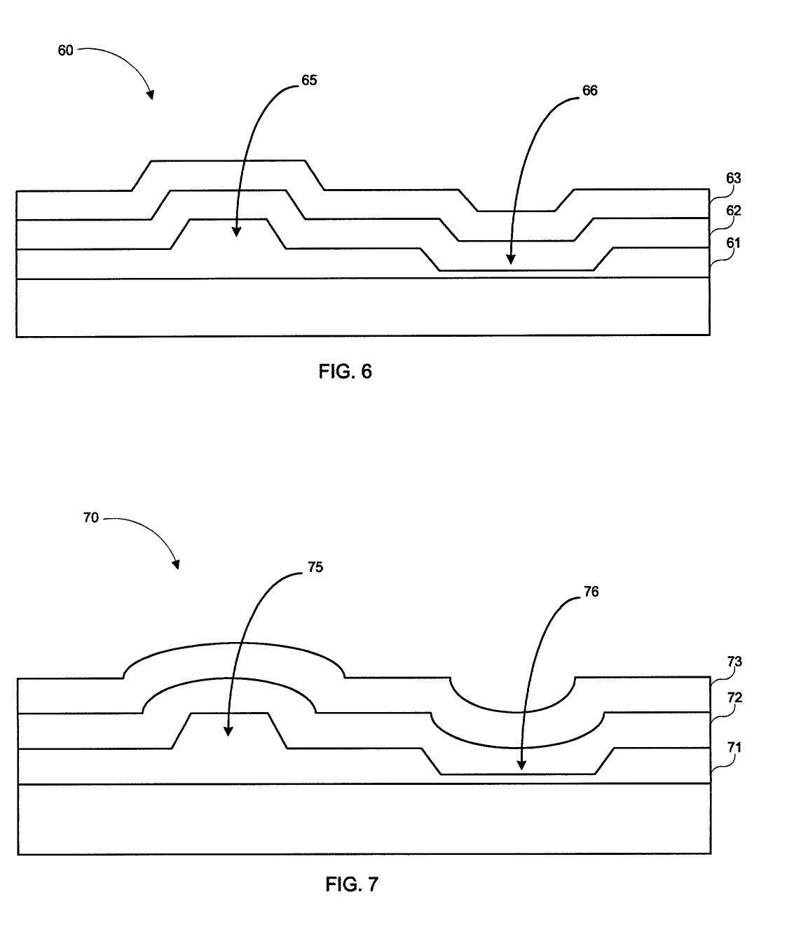

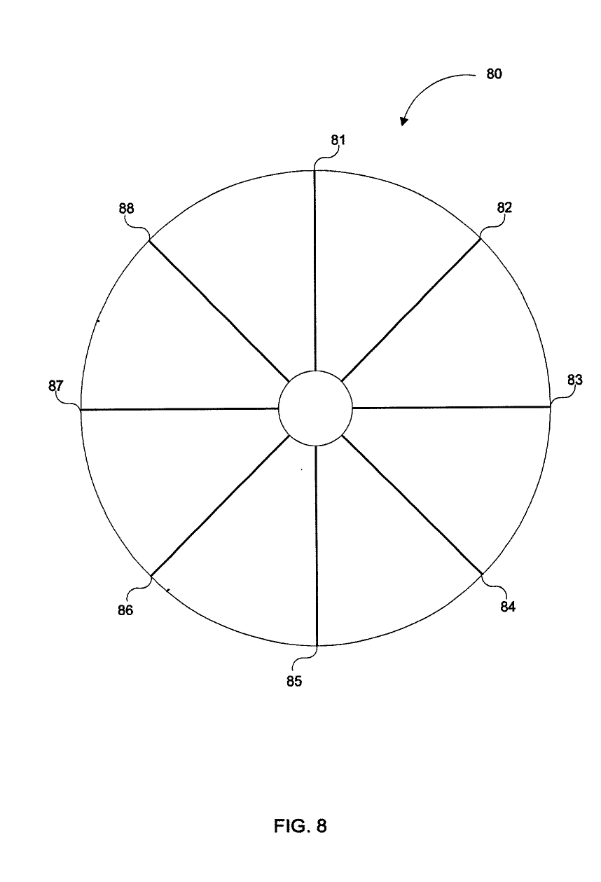

FIGS. 6 and 7 are cross-sectional diagrams of data storage media 60, 70. Surface variations may be protrusions 65, 75 or depressions 66, 76 in a second layer 61, 71. A third layer 62, 72 may have concomitant conforming surface variations. Moreover, the concomitant conforming surface variations of the third layer 62, 72 may substantially conform to the surface variations 65, 75. The substantially conforming variations of the third layer may not be a perfect match, as shown in FIGS. 6 and 7. Thus, the exact shape of the variations may not be preserved through the different layers. Importantly, however, the existence of and general nature of the variations (e.g. a protrusion or depression) is preserved on the medium's surface. Additional layers, which also substantially conform to the surface variation, such as a fourth layer 63, 73 may also be added.

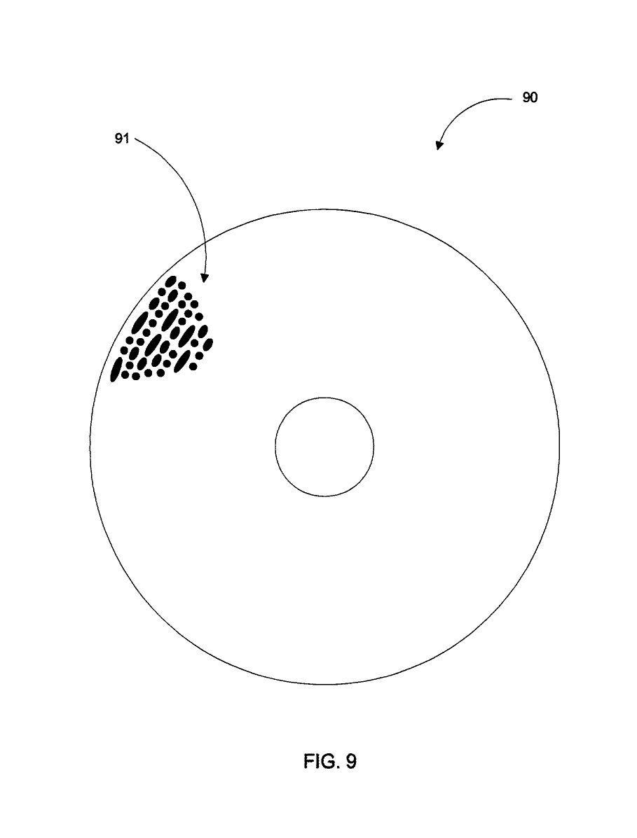

FIGS. 8 and 9 are top view diagrams of a data storage media 80 and 90 in the form of disks. In FIG. 8, the surface variations (as shown in FIGS. 1-7) may take the form of servo patterns 81, 82, 83, 84, 85, 86, 87, 88. With the current state of the art, pattern or servo writing is a major expense in the production process for flyable media because each mark must be written on each medium. The patterns of FIG. 8, however, are surface variations that can be embossed, molded, ablated, or the like as part of a disk fabrication process. For this reason, FIG. 8 illustrates a flyable medium that may yield substantially lower production costs. Servo patterns 81, 82, 83, 84, 85, 86, 87, 88 may be protrusions, depressions, or a combination of protrusions and depressions. If the servo patterns 81, 82, 83, 84, 85, 86, 87, 88 are protrusions, they may protrude from the medium 80 to a height less than the fly height. For instance, if the fly height is 50 nanometers, the servo patterns may protrude from medium 80 to a height less than 50 nanometers. Similarly, if the fly height is 20 nanometers, the servo patterns may protrude from medium 80 to a height less than 20 nanometers.

In FIG. 9, the surface variations take the form of data patterns comprising a collection of data bumps 91. The bumps 91 are enlarged for illustrative purposes in FIG. 9, and may have a track pitch as small as 200 nanometers, a bit pitch as small as 200 nanometers and a height of less than 50 nanometers.

In one specific embodiment, a plurality of oval shaped data bumps 91 are implemented on a medium 90. Some bumps 91 may have surface areas less than 40,000 square nanometers. Moreover, these data bumps may project from the medium to a height less than the fly height. For instance, a medium designed to fly at a height of 25 nm may have bumps that project form the article to a height less than 20 nm. Bumps of this size may allow significant areal density of read-only data (>5 Gigabits/in²) while still ensuring that the article maintains a flyable surface for a read head.

The surface variations shown in FIGS. 8 and 9 may be bumps, lands, rails, pits, grooves, channels, ridges, or any other surface variation or combination thereof, as long as the layers above the layer exhibiting the surface variations substantially conform to the variations. This may permit detection of the surface variation pattern on the exterior surface of the data storage media 80, 90.

Referring again to FIG. 1, in one particular embodiment, the first layer 10 may be a glass substrate and the second layer 12 may be a photopolymer film embossed with bumps (such as surface variation 18). The film may be embossed by a stamper and cured via exposure to radiation through the glass substrate. The third layer 14 may be a magnetic thin film stack and may include a chrome alloy underlay, a cobalt alloy magnetic layer, and a carbon overcoat for hard-coat protection. The fourth layer 16 may be lubricant. The embossed bumps may be in a read only format and can be read by a thermal sensitive or a pressure sensitive flying head. Furthermore, data can be written to and read from the thin film stack layer of the medium.

Referring again to FIG. 2, in yet another embodiment, surface variations are depressions (shown at 28) such as grooves. The grooves may have width of 200 nm and depth 90 nm may be embossed in the second layer 22 that was previously spin-coated onto a first layer 21 such as a polished glass disk. The third layer 24 may be a magnetic thin film stack may include a chrome alloy underlay, a cobalt alloy magnetic layer, and a carbon overcoat for hard-coat protection. A fourth layer 26 may include a lubricant. Both the magnetic thin film stack and the lubricant substantially conform to the grooves in the second layer. In some embodiments, grooves may define tracks in the medium. Moreover, because of the depth of the grooves, an MR head may not write magnetic domains in the grooves.

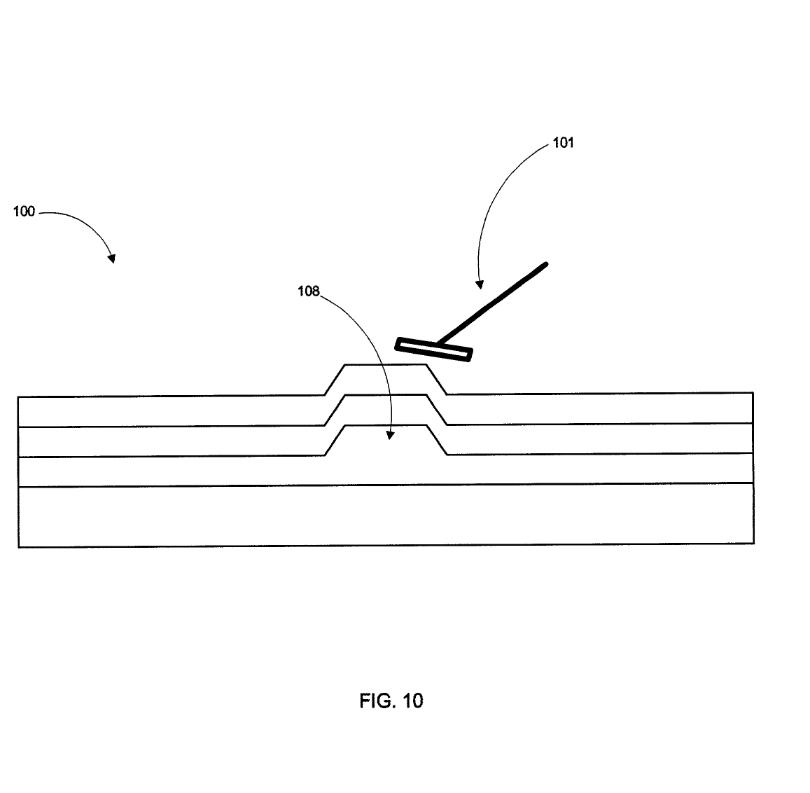

FIG. 10 is the same cross sectional diagram of FIG. 1 with a flyable transducer 101 flying over the medium 100. Transducer 101 is not drawn to scale relative to surface variation 108. Transducer 101 may be designed as a pressure or temperature sensitive transducer, and may detect the surface variation 108 as it passes over it. In one embodiment, transducer 101 may be a normal MR head such as those implemented in typical hard drive systems. Normal MR heads have an inherent sensitivity to temperature variation. For this reason, transducer 101 may be a normal MR head used in a hard drive system. A system for reading the surface variation 108 may include a processor connected to the head and configured to detect surface variations via the inherent temperature sensitive nature of the MR head.

In one embodiment, a transducer is used to read surface variations in the following manner. As the transducer flies over the recording medium, the topography of the recording medium (as defined by surface variations) creates detectable changes in the ambient conditions between the transducer and the medium. The transducer may produce a signal representative of such changes. Therefore, data may be encoded in the surface variations or topography by intentionally arranging such features of the recording medium to represent the data into a so-called “machine readable” form.

One type of ambient condition change that may be detected is a temperature change. For example, as the distance between the transducer surface and the surface feature rapidly decreases due to passage of the transducer over a protruding surface variation, the temperature may decrease in the transducer because of a decrease in air space insulation between the transducer and the medium. The opposite may occur when the transducer passes over a depression. A temperature sensitive transducer can therefore detect machine-readable data represented by such variations.

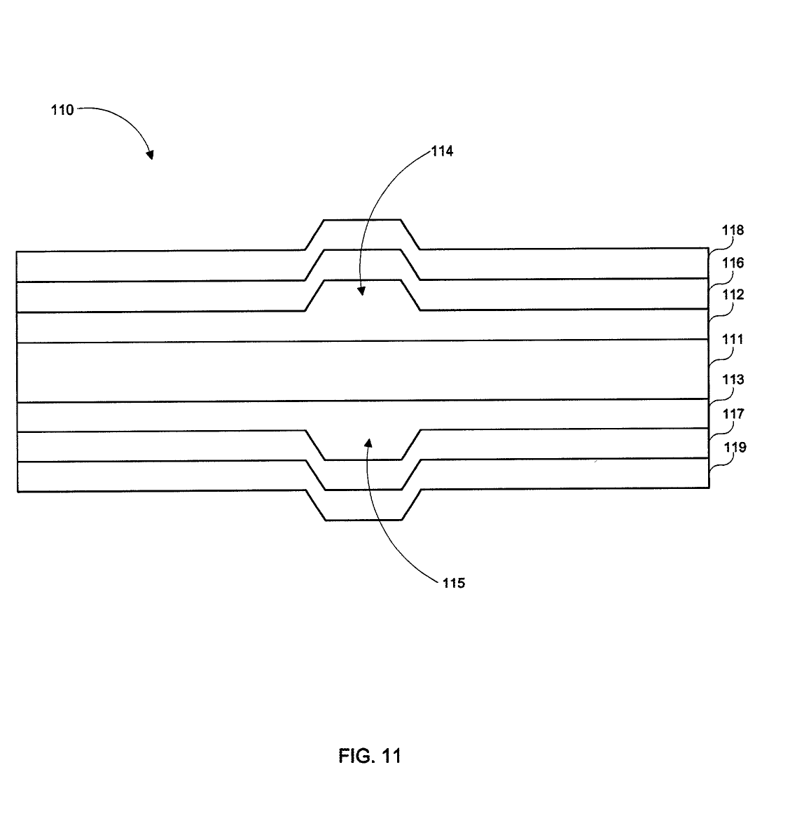

FIG. 11 is another cross sectional diagram of a data storage medium 110. As shown, a single substrate 111 may have two second layers 112, 113 on opposite sides of the substrate 111. These second layers 112, 113 may each include one or more surface variations 114, 115. Each side may also have third layer 116, 117 that substantially conforms respectively to surface variations 114, 115. Moreover, each side may have a fourth layer 118, 119 that substantially conforms respectively to surface variations 114, 115. The surface variations 114, 115 may be servo patterns (as shown in FIG. 8), or data patterns (as shown in FIG. 9).

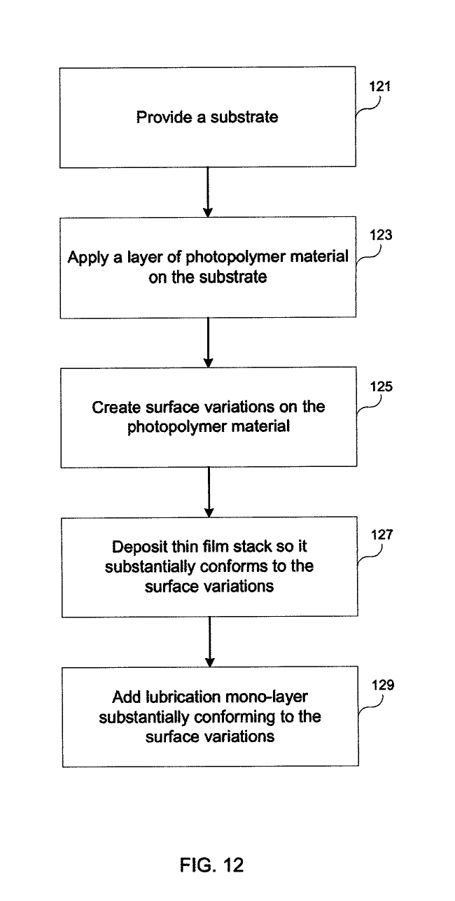

FIG. 12 is a flow diagram illustrating one fabrication technique for creating a data storage medium as described herein. As shown, a substrate is provided (121). The substrate may be prefabricated and polished for flyability. In some exemplary embodiments, the substrate is made of glass, aluminum, aluminum-magnesium, ceramic or plastic. Moreover, in some embodiments, the substrate comprises a traditional storage media. In other embodiments, the substrate is substantially transparent. After a substrate has been provided (121), a layer of photopolymer material may be applied on the substrate (123). By way of example, the photopolymer material may be applied by a spin coating technique or a roll coating technique.

In a spin coating technique, a spinner is used to coat a disk substrate with a thin film of photopolymer. A bead of photopolymer is dispensed near the inner diameter of the disk as the disk is spinning at low speeds, typically 100 rpm. The disk is then accelerated to high speeds, typically 3000 rpm to 6000 rpm, spreading the photopolymer across the disk to a uniform layer. Various parameters, such as spin speed, spin time, acceleration, solvent viscosity, and solvent distribution determine both the final thickness and uniformity of the thin film.

In a roll coating technique, a thin film of photopolymer is first applied to a roller by various methods such as lapping of a reservoir. The roller then transfers the thin film to the substrate as they make contact.

Whichever technique is used, the photopolymer material should generally have a uniform thickness. A primer material may be applied prior to photopolymer coating to enhance adhesion of the photopolymer to the disk substrate. The primer can also be applied by similar techniques, such as spin coating or roll coating. Flyability of the surface may be maintained when the photopolymer material is applied. However, in some cases, applying the photopolymer material can enhance flyability of the surface.

The photopolymer may be chosen to maintain or enhance flyability, produce an abrasion resistant surface, and produce a surface amicable to a sputtering process. In one embodiment, the photopolymer includes at least 30% ambifunctional silanes. In another embodiment, the photopolymer includes at least 15% heterocyclic acryloyloxy materials.

In yet another embodiment, the photopolymer includes 30% to 70% by weight hexanediol diacrylate, 30% to 70% by weight hydantoin hexacrylate, and less than five percent by weight of initiator. This formulation has at least three important properties for a flyable data storage medium. First, after curing, the photopolymer may have excellent abrasion resistance properties. This may be especially important for protection of the medium from damage caused by inadvertent head-media contact. Second, the cured photopolymer may have thermal stability to at least 400° C. This may allow for better production of sputtered thin films by heating of the substrate than those sputtered on an unheated plastic substrate. Third, this formulation may be solvent free enabling the replication process to produce a good flyability layer without trapping solvents in the layer during cure.

After the layer of photopolymer material has been applied to the substrate (123), surface variations may be created on the photopolymer (125). Creating surface variations can done in numerous different ways. For instance, each device could be individually etched with the desired surface variations. However, mass production techniques that realize economies of scale may provide a much more cost-effective means of production. One mass production technique that could be used to create surface variations on a photopolymer (125) involves the creation of a master and a stamper.

Briefly, the mass production master/stamper techniques may involve creating a master disk having the inverse of the desired surface variations. The disk mastering process may include exposing a layer of photoresist down to the disk substrate, resulting in the formation of a master having uniform master groove bottoms defined by the master substrate. These master grooves may be the inverse of the desired surface variations.

After creating a suitable master, the master may then used to make at least one first-generation stamper, such as a PMMA stamper or a nickel stamper. The first-generation stamper may then be used to create a second-generation stamper that has a uniform stamper groove bottom. This second-generation stamper, then, may be used to stamp a vast number of replica disks in a stamping process. The inverse of surface variations may be exhibited on the surface of the second-generation stamper. Moreover, because the second-generation stamper has a uniform stamper groove bottom, each replica disk stamped by the second-generation stamper may have a flyable surface.

A nickel stamper may be created from a master by coating the master with a thin layer of nickel. The coated master is then placed in a nickel sulphamate bath causing a thick layer of nickel to solidify on the nickel-plated master. This collection of nickel may then be removed from the master and used as a stamper. The nickel stamper may be used to emboss surface variations, or alternatively can be used to create a plurality of second-generation stampers and/or third generation stampers. As mentioned above, second generation stampers, may be particularly useful for stamping surface variations while maintaining flyable surface on the medium. Once the desired stamper has been created, it may be used to emboss a vast number of identical media storage devices in a stamping process.

The stamping process involves making contact between the photopolymer material on the substrate and the stamper. The photopolymer material is then cured, by exposing the material to ultraviolet radiation. Moreover, in embodiments where the substrate is substantially transparent, exposure to ultraviolet radiation may occur through the substrate. At this point the stamper may be pealed away from the substrate leaving an inverted image of the stamper on the photopolymer material. This inverted image may include the desired surface variations.

In one method of fabrication, a rolling bead technique may be used to both apply a layer of photopolymer material on the substrate (123) and create the surface variations on the photopolymer material (125). In the rolling bead technique, a bead of photopolymer material is placed just beyond a contact line of a stamper and a substrate. A roller then rolls over the stamper, simultaneously creating a layer of photopolymer on the substrate and embossing the surface variations of the stamper onto the photopolymer. The photopolymer may then be cured (e.g. by exposing it to radiation through the substrate) before the stamper is peeled from the substrate.

In yet another method of fabrication a reaction injection molding technique is used to both apply a layer of photopolymer material on the substrate (123) and create the surface variations on the photopolymer material (125). In a reaction injection molding technique, a mold is created having the desired surface variations, and a substrate is placed in the mold. A photopolymer may then be injected into the mold and cured (e.g. by exposing it to radiation through the substrate). In this manner, surface variations may be created in the photopolymer before the substrate is removed from the mold.

After the surface variations have been created on the photopolymer material (125), a thin film stack may be deposited on the photopolymer so that it substantially conforms to the surface variations (127). One effective way of depositing a thin film stack on the photopolymer so that it substantially conforms to the surface variations involves sputtering, e.g. by placing the media device in a vacuum chamber with a target and a gas such as argon or nitrogen. The target is composed of the desired material (e.g. a buffer material, an underlayer, a magnetic material, a hard coat material or any other material needed in the thin film stack). A voltage may be applied to the target, creating a voltage potential between the target and the media device. This potential, in turn, creates a plasma of argon ions, nitrogen ions, or argon and nitrogen ions (depending on which gas is used). The ions are attracted to the voltage-biased target and collide with the target material. As a result of the collision, target molecules break from the target and deposit on the media device.

After the thin film stack has been deposited (127) (including a boundary layer and a hard coat, if desired), a lubrication layer may be applied, substantially conforming to the surface variations embossed on the photopolymer (129). To add a lubrication layer substantially conforming to the surface variations, the medium may be dipped in a high vapor pressure lubrication solution, such as an available fluorocarbon lubricant, and removed slowly. This may leave a thin layer of lubrication molecules on the device. At this point, the thin layer may or may not be cured with ultra violet radiation.

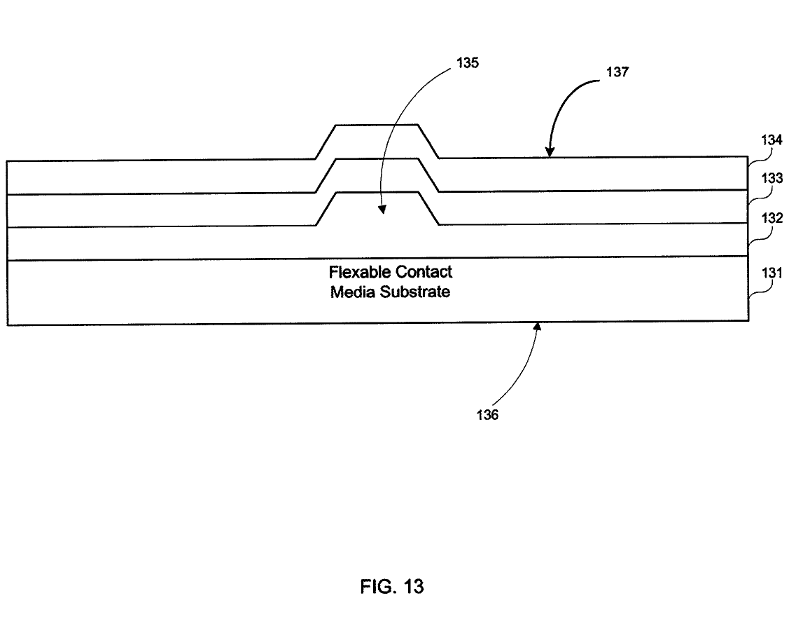

FIG. 13 is a cross sectional diagram illustrating another embodiment of a data storage medium. The medium may include a flexible contact media substrate 131 and a polymer layer 132. The polymer layer 132 may contain one or more surface variations 135. The medium may also include a thin film stack 133 substantially conforming to the surface variations 135. In this manner, surface variations 135 may remain transducer detectable. In addition, the medium may include a lubrication layer 134 substantially conforming to the surface variations 135. The surface variations 135 may be servo patterns (as shown in FIG. 8), or data patterns (as shown in FIG. 9).

In one embodiment, the medium in FIG. 13 may be a hybrid contact medium. Data may be written to and read from the magnetic substrate on surface 136 while surface 137 provides tracking information to a contact head in a disk drive. Fabrication of a medium as shown in FIG. 13 may be achieved by following the steps of the flow diagram in FIG. 12.

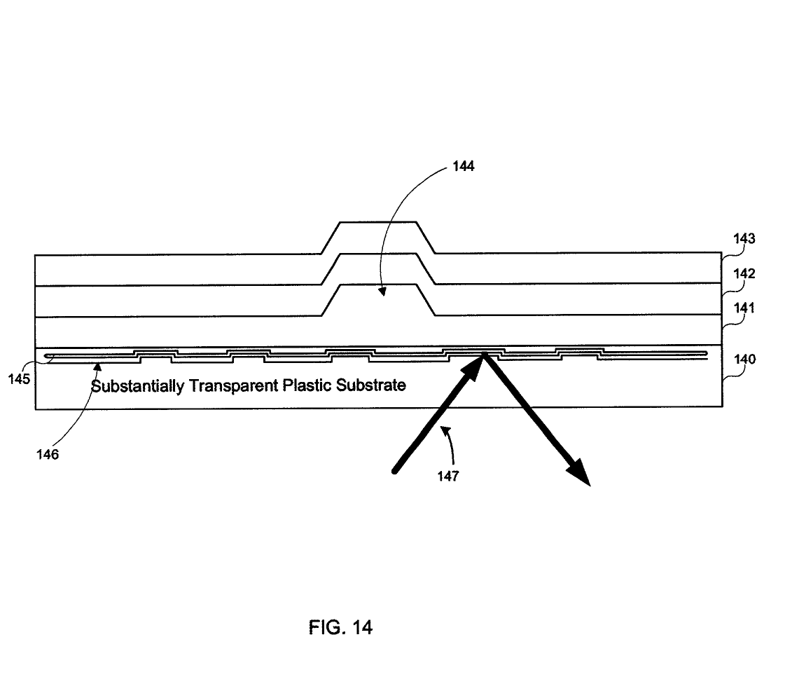

FIG. 14 is a cross sectional diagram illustrating another embodiment of a data storage medium. The medium may include a substantially transparent plastic substrate 140 and a polymer layer 141 containing one or more surface variations 144. In addition, the medium may include a thin film stack 142 substantially conforming to the surface variations. Moreover, the medium may include a lubrication layer 143 substantially conforming to the surface variations. Because thin film stack 142 and lubrication layer 143 substantially conform to the surface variations, those variations remain transducer detectable on the surface of the medium.

A reflective layer 145 may facilitate optical detection of features 146 contained in the substrate 140. For instance, an optical signal (such as a laser 147) may interrogate the substrate and reflect off the reflective layer 145. Features 146 may diffract the laser 147 in a manner consistent with the data encoded in features 146. In this way, data encoded in features 146 can be detected.

The medium of FIG. 8 may be a hybrid flying head/optical medium. Substrate 80 may be part of an optical data disk such as a disk similar to an audio CD (compact disc), CD-R (CD-recordable), CD-RW (CD-rewriteable), CD-ROM (CD-read only memory), DVD (digital versatile disk or digital video disk) medium, DVD-RAM (random access memory), or any other type of optical medium, such as a disk similar to a magnetooptical (MO) disk. In one embodiment, surface variations 144 contain read-only encoded data while the optical substrate 140 is rewriteable. In other embodiments, the surface variations may be servo patterns (as shown in FIG. 8), or data patterns (as shown in FIG. 9). In operation, a flying head transducer may be used to read the read-only surface variations while an optical laser is used to read and write to the optical substrate 140. Fabrication of a hybrid flying head/optical medium as shown in FIG. 14 may be achieved by following the steps of the flow diagram in FIG. 12.

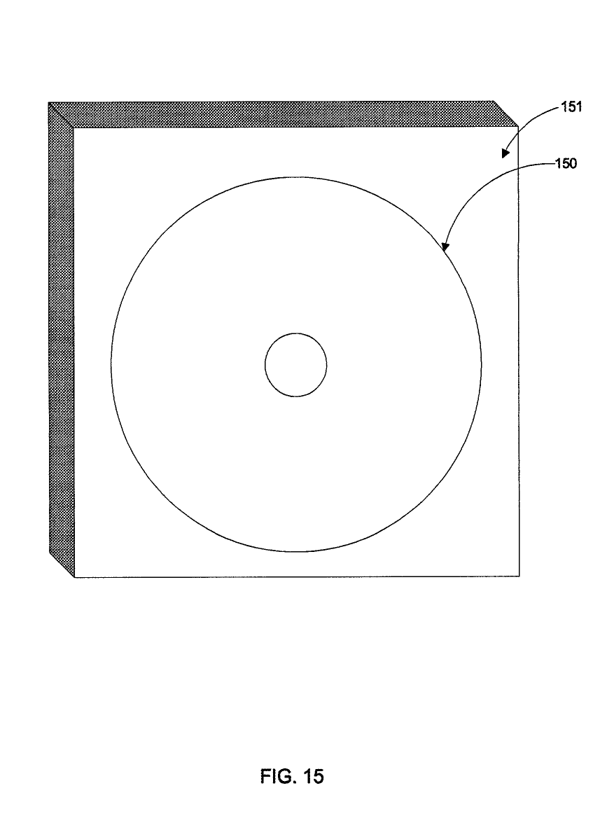

FIG. 15 shows a data storage medium 150 encased in a housing 151. When medium 150 is implemented in a removable hard disk system, housing 151 may be necessary to protect the medium from environmental corruption.

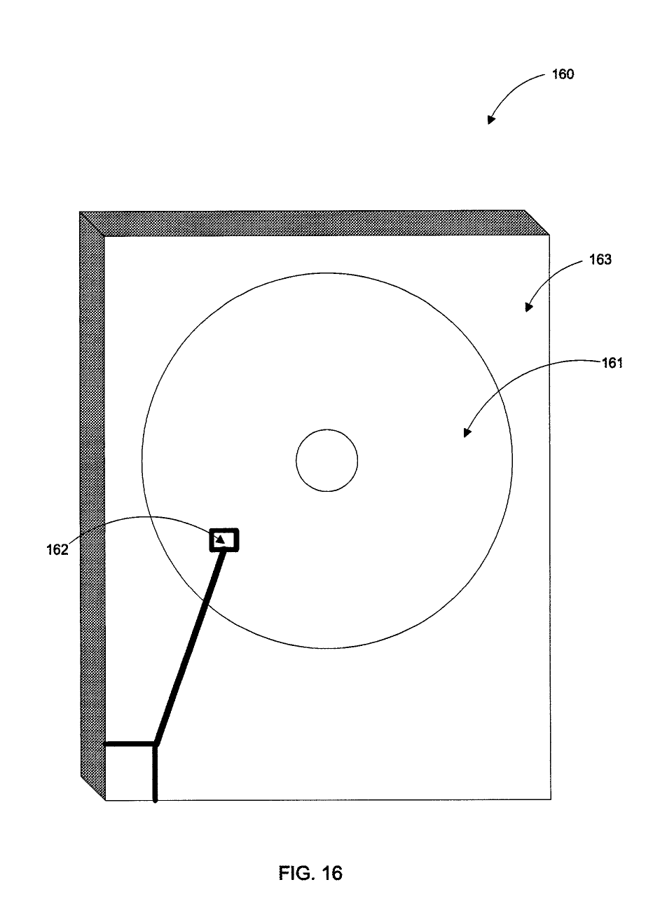

FIG. 16 shows a data storage medium 161 used in a non-removable hard disk unit 160. Hard disk unit may include a flying head transducer 162 and a data storage medium 161 enclosed within a housing 163. The data storage medium 161 may be configured as described in one or more of the examples above.

A number of embodiments have been described. For instance, a data storage medium having a second layer exhibiting surface variations has been described. Additional layers may substantially conform to the surface variations. For this reason, the additional layers may have concomitant conforming surface variations. These and other embodiments are within the scope of the following claims.

We claim:

1. A data storage medium comprising:
a first layer;
a second layer including a polymer, the second layer exhibiting surface variations; and
a third layer substantially conforming to the surface variations of the second layer.

2. The data storage medium as describe in claim 1, wherein the first layer is a substrate.

3. The data storage medium as described in claim 1, wherein the first layer is a disk.

4. The data storage medium as described in claim 1, wherein the first layer provides rigidity and mechanical stability to the article.

5. The data storage medium as described in claim 1, wherein the first layer is comprised of one of the following: glass, aluminum, aluminum-magnesium alloy, ceramic and plastic.

6. The data storage medium as described in claim 1, wherein the polymer includes a photopolymerized material.

7. The data storage media as described in claim 6, wherein the polymer comprises at least 30% by weight of radiation polymerized components selected from epoxy-terminated silanes.

8. The data storage medium as described in claim 1, wherein the surface variations are machine-readable data patterns.

9. The data storage medium as described in claim 8, wherein the data patterns include data bumps.

10. The data storage medium as described in claim 9, wherein at least some of the data bumps comprise encoded data.

11. The data storage medium as described in claim 1, wherein the surface variations are protrusions.

12. The data storage medium as described in claim 11, wherein the surface variations include at least one of the following: bumps, rails, lands and ridges

13. The data storage medium as described in claim 1, wherein the surface variations are depressions.

14. The data storage medium as described in claim 13, wherein the surface variations include at least one of the following: pits, grooves, and channels.

15. The data storage medium as described in claim 1, wherein the surface variations contain servo patterns.

16. The data storage medium as described in claim 1, wherein the surface variations contain tracking patterns.

17. The data storage medium as described in claim 1, wherein the surface variations project from the article a height less than 50 nanometers.

18. The data storage medium as described in claim 1, wherein the third layer includes a magnetic recording material.

19. The data storage medium as described in claim 1, wherein the third layer includes an optical recording material.

20. The data storage medium as described in claim 1, wherein the third layer includes a thin film stack.

21. The data storage medium as described in claim 1, wherein the third layer includes a hard coat.

22. The data storage medium as described in claim 21, wherein the hard coat includes at least one of the following: carbon, nitrogenated-carbon, and hydrogenated-carbon.

23. The data storage medium as described in claim 1, wherein the third layer includes a buffer.

24. The data storage medium as described in claim 1, further comprising a fourth layer substantially conforming to the surface variations of the second layer.

25. The data storage medium as in claim 24, wherein the fourth layer includes a lubricating material.

26. The data storage medium as in claim 1, wherein at least one medium surface is flyable.

27. A data storage medium comprising:
a substantially rigid substrate,
a polymer containing surface variations;
a thin film stack substantially conforming to the surface variations; and
a lubrication layer substantially conforming to the surface variations,
wherein the surface variations are arranged in a machine-readable pattern.

28. A data storage medium comprising:
a flexible contact media substrate;
a polymer containing surface variations; and
a thin film stack substantially conforming to the surface variations; and
a lubrication layer substantially conforming to the surface variations,
wherein the surface variations are arranged in a machine-readable pattern.

29. A data storage medium comprising:
a substantially transparent plastic substrate;
a reflective layer;
a polymer containing surface variations;
a thin film stack substantially conforming to the surface variations; and
a lubrication layer substantially conforming to the surface variations,
wherein the surface variations are arranged in a machine-readable pattern.

30. A data storage medium comprising:
a first data storage layer;
a second data storage layer, the second data storage layer including a polymer containing surface variations;
a thin film stack substantially conforming to the surface variations; and
a lubrication layer substantially conforming to the surface variations,
wherein the surface variations are arranged in a machine-readable pattern.

31. A removable hard disk unit comprising:
a housing; and
a data storage unit within the housing comprising:
a first layer;
a second layer including a polymer, the second layer exhibiting surface variations; and
a third layer substantially conforming to the surface variations of the second layer.

32. A system comprising:
a housing;
a flying head transducer within the housing; and
a data storage unit within the housing comprising:
a first layer;
a second layer including a polymer, the second layer exhibiting surface variations; and
a third layer substantially conforming to the surface variations of the second layer.

33. A method comprising:
providing a substrate;
applying a polymer film on the substrate;
creating one or more surface variations on the film;
applying an additional layer over the film such that the additional layer substantially conforms to the surface variations.

34. The method of claim 33, further comprising applying a plurality of additional layers over the film such that the plurality of additional layers substantially conform to the surface variations.

35. The method of claim 33, wherein applying a film on the substrate comprises spin coating the substrate.

36. The method of claim 33, wherein applying a film on the substrate comprises roll coating the substrate.

37. The method of claim 33, wherein creating one or more surface variations comprises stamping the film with a stamper.

38. The method of claim 33, wherein applying a film on the substrate and creating the one or more surface variations comprises a reaction injection molding process.

39. The method of claim 33, wherein applying a film on the substrate and creating the one or more surface variations comprises a rolling bead process.

40. The method of claim 33, wherein the polymer film comprises less than 1% solvent.

41. The method of claim 33, wherein the polymer film comprises at least 30% ambifunctional silanes.

42. The method of claim 33, wherein the polymer film comprises at least 15% heterocyclic acryloyloxy materials.

43. The method of claim 33 wherein the polymer film comprises 30% to 70% hydantoin hexacrylate.
